(19) United States
(12) Patent Application Publication
(10) Pub. No.: US 2003/0170002 A1
(43) Pub. Date: Sep. 11, 2003

(54) Video composition and editing method

(76) Inventor: Benoit Mory, Paris (FR)

Correspondence Address: PHILIPS INTELLECTUAL PROPERTY & STANDARDS, P.O. BOX 3001, BRIARCLIFF MANOR, NY, 10510, US

(21) Appl. No.: 10/373,441

(22) Filed: Feb. 25, 2003

(30) Foreign Application Priority Data
Feb. 26, 2002 (FR) 0202396

(51) Int. Cl. H04N 5/93; G11B 27/00

(52) U.S. Cl. 386/52; 386/64

(57) ABSTRACT

The invention proposes a video composition and editing method that is easy to use and can be implemented on consumer equipment having only limited display and/or calculating capacity.

The invention comprises employing a description of the video input material Vi (such as a description of the MPEG-7 type for example), and asking the user to supply a multi-part plan for the video material Vo that he wishes to obtain as an output. The plan is then analyzed part by part to generate a search criterion relating to each part. A search is then made in the description D for each search criterion generated. The video segments that are selected in this way are juxtaposed to form the video output material.

Applications: non-professional video composition and editing, digital cameras taking still or moving pictures.

### FIELD OF THE INVENTION

The invention relates to a composition and editing method for producing output material from input material comprising images and/or image sequences. The invention also relates to a program comprising instructions for implementing a composition and editing method of this kind when the program is run by a processor.

The invention also relates to an item of electronic equipment fitted with means for reading input material comprising images and/or image sequences, and with means for processing said input material to produce output material from said input material.

### BACKGROUND OF THE INVENTION

U.S. Pat. No. 5,404,316 describes a method of video processing that enables video editing to be carried out. The method described in this patent is adapted to professional applications. It is too complex to be used by the general public. It is also too complex to be implemented on consumer electronic equipment that has only limited processing and/or display capabilities, and in particular on portable electronic equipment.

### OBJECT AND SUMMARY OF THE INVENTION

It is an object of the invention to propose a method of composition and editing intended for use by the general public that is capable of being implemented on consumer electronic equipment having limited processing and/or display capabilities, such as on digital cameras taking still or moving pictures.

This object is achieved by a composition and editing method according to the invention as described in the opening paragraph, that is characterized in that it comprises:

at least one step for acquiring a plan that is in a plurality of parts and relates to said output material,

at least one step for selecting, from a description of said input material, images and/or image sequences corresponding to said parts,

at least one step for placing in order, in accordance with said plan, the images and/or image sequences selected.

Optionally, to allow said description to be generated, a composition and editing method according to the invention may also comprise:

a step for automatically extracting a structure from said input material,

a step for annotating said structure from semantic information supplied by a user.

Hence, in accordance with the invention, rather than carrying out conventional composition and editing operations such as selecting, cutting and collating images or image sequences, the user supplies a plan for the output material and, in certain cases, he annotates a structure characteristic of said input material, said structure being obtained by automatic extraction. The composition and editing is then performed automatically by following the plan defined by the user.

The plan for the output material and the semantic information are supplied by the user in his natural language, such as manually by using a keyboard or orally by using voice recognition tools.

The operations that are carried out in accordance with the invention by the user are thus far more simple than those that have to be carried out with a prior art composition and editing method. They do not call for any specific know-how. In particular, there is no need to know how to operate the computerized tool correctly in order to use a composition and editing method according to the invention.

What is more, it is not necessary to have a sophisticated user interface available in order to implement a composition and editing method according to the invention. Consequently, the invention may be implemented in a wide variety of items of electronic equipment and in particular in items of portable electronic equipment such as digital cameras taking still or moving pictures.

The invention also has the advantage of enabling the user to modify the composition obtained and to do so simply and as many times as he wishes. This is because a set of video output material Vo may form new input material Vi′ for a re-run of the composition and editing method according to the invention. All that is needed to obtain a new composition is for the plan P to be amended, such as by deleting or moving a sentence for example.

### BRIEF DESCRIPTION OF THE DRAWINGS

These and other aspects of the invention are apparent from and will be elucidated with reference to the embodiments described hereinafter.

In the drawings, which are given by way of non-limiting example:

FIG. 1 is a diagram showing the main steps of a composition and editing method according to the invention.

FIG. 2 shows an example of an item of electronic equipment according to the invention.

### DESCRIPTION OF AN EMBODIMENT OF THE INVENTION

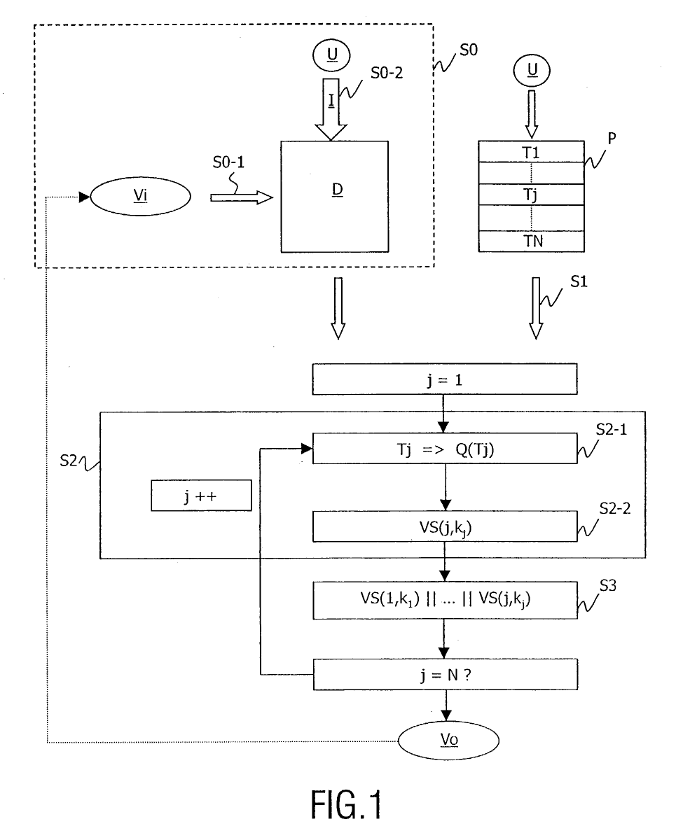

Shown in FIG. 1 is a diagram that summarizes the various steps of a composition and editing method according to the invention. The composition and editing method according to the invention allows output material Vo to be generated from input material Vi, comprising images and/or image sequences, by taking account of instructions defined by a user U.

The composition and editing method according to the invention makes use of a description D of the input material Vi.

The method according to the invention comprises a step S1 for the acquisition of a plan P relating to the output material that the user wishes to obtain. This plan P is defined by the user U. It comprises a plurality of parts Tj (j=1 . . . N).

The method according to the invention comprises selecting steps S2 for selecting from the description D images and/or image sequences that correspond to each of the parts Tj of the plan P. It also comprises ordering steps S3 for placing in order the images and/or image sequences that are selected under the plan P.

To carry out steps S2 and S3, plan P is run through part by part. For each part Tj:

a step S2-1 for the logic analysis of the content of part Tj enables a search criterion relating to said part to be generated,

a step S2-2 for searching in the description D enables one or more images and/or image sequences VS(j, kⱼ) that meet the search criterion Q(Tj) to be selected,

and the ordering step S3 comprises adding the images and/or image sequences selected to the succession of images and/or image sequences selected previously.

The succession of images and/or image sequences obtained at the end of the last, ordering step S3 forms the output material Vo. This output material Vo may form fresh input material Vi′ for a re-run of steps S1, S2 and S3. When this is the case, the user may, in step S1, either define a new plan P′, or amend the original plan P by adding, deleting or moving one or more parts Tj.

The composition and editing method according to the invention advantageously comprises an optional step S0 for generating the description D. Step S0 is carried out when there is no description available for the input material Vi. Step S0 advantageously comprises:

a step S0-1 for automatically extracting a structure from the input material Vi,

a step S0-2 for annotating said structure from semantic information supplied by the user.

Tools for generating a description of such input material are described in, for example, the article entitled “A Survey on the Automatic Indexing of Video Data” that was published by R. Brunelli, O. Mich and C. M. Modena in the publication “Journal of Visual Communication and Image Representation” 10, 78-112 (1999).

The description that is produced by tools of this type advantageously complies with the MPEG-7 standard. An MPEG-7 description is a hierarchical structure of video segments that comprise elements that are instances of descriptors defined in the MPEG-7 standard. Among the descriptors defined in the MPEG-7 standard are ones that are intended for use for describing conceptual aspects that cannot automatically be deduced from the input material (such as context, location, time, action, objects, persons, etc.). The content of the elements that are instances of such descriptors has to be supplied by an operator. When the composition and editing method according to the invention comprises a step S0 for generating the description D, the content of the elements that are instances of such descriptors is formed by the semantic information I supplied by the user U.

To enable a correspondence to be established between the plan P and the description D, it is necessary for the plan P and the semantic information I to be defined in the same language, such as in the language spoken by the user U. This being the case, each part Tj of the plan P is formed by a sentence. The plan P and the semantic information I are entered manually by using a keyboard, or orally by using voice recognition means.

An example of a description D will now be given for input material formed by video sequences that were filmed by the user during his vacation (the description D is a description that complies with the MPEG-7 standard; it is written in the XML markup language defined by the W3C consortium):

Example of a Description

<?xml version=“1.0” encoding=“ISO-8859-1”?>
<Mpeg7Main xmins:xsi=“http://www.w3c.org/XML_schema”>
<ContentDescription xsi:type=“ContentEntityDescriptionType”>
<AudioVisualContent xsi:type=“AudioVisualType”>
<MediaLocator>

<MediaURI>file:///D:\VIDEOS\vacation.mpg</MediaURI>

</MediaLocator>
<AudioVisual id=“My vacation in France”>
<MediaInformation>

<MediaProfile>

<MediaFormat)
<Content>video<Content>
<FrameRate>25.0</FrameRate>
<MediaFormat>

<MediaProfile>

</MediaInformation>
<SegmentDecomposition decompositionType=“temporal” gap=“true”id=“TableOfContent”
overlap=“false”>
<Segment id=“Arrival in Paris” xsi:type=“AudioVisualSegmentType”>

<TextAnnotation>

<StructuredAnnotation>

<Where>Paris</Where>
<When>21 Jul. 2000</When>
<How>By air</How>

<StructuredAnnotation>

</TextAnnotation>
<MediaTime>

<MediaRelIncrTimePoint timeBase=“MediaLocator[1]”
timeUnit=“PT1N25F”>5</MediaRelIncrTimePoint>
<MedialnerDuration timeUnit=“PT1N25F”>11</MediaIncrDuration>

</MediaTime>

</Segment>
<Segment id=“Visit to Eiffel Tower” xsi:type=“AudioVisualSegmentType”>

<TextAnnotation>

<StructuredAnnotation>

<WhatObject>Eiffel Tower</WhatObject>
<WhatAction>Visit,/WhatAction>
<Where>Paris</Where>
<When>22 Jul. 2000</When>

<StructuredAnnotation>

</TextAnnotation>
<MediaTime>

<MediaRelIncrTimePoint timeBase=“MediaLocator[1]”
timeUnit=“PT1N25F”>16</MediaRelIncrTimePoint>
<MediaIncrDuration timeUnit=“PT1N25F”>37</MediaIncrDuration>

</MediaTime>

</Segment>
<Segment id=“Walk round the Pantheon” xsi:type=“AudioVisualSegmentType”>

<TextAnnotation>

<StructuredAnnotation>

<WhatObject>Pantheon</WhatObject>
<When>23 Jul. 2000</When>

<StructuredAnnotation>

</TextAnnotation>
<MediaTime>

<MediaRelIncrTimePoint timeBase=“MediaLocator[1]”
timeUnit=“PT1N25F”>53</MediaRelIncrTimePoint>
<MedialncrDurationtimeUnit=“PT1N25F”>28</MediaIncrDuration>

</MediaTime>

</Segment>
<Segment id=“Romantic evening meal” xsi:type=“AudioVisualSegmentType”>

<TextAnnotation>

<StructuredAnnotation>

<WhatAction>Evening meal</WhatAction>
<Where>Restaurant</Where>

<StructuredAnnotation>

</TextAnnotation>
<MediaTime>

<MediaRelIncrTimePoint timeBase=“MediaLocator[1]”
timeUnit=“PT1N25F”>81</MediaRelIncrTimePoint>
<MediaIncrDurationtimeUnit=“PT1N25F”>20</MediaIncrDuration>

</MediaTime>

</Segment>
<Segment id=“Our hotel” xsi:type“AudioVisualSeamentType”>

<MediaTime>

<MediaRelIncrTimePoint timeBase=“MediaLocator[1]”
timeUnit=“PT1N25F”>101</MediaRelIncrTimePoint>
<MediaIncrDurationtimeUnit=“PT1N25F”>22</MediaIncrDuration>

</MediaTime>

</Segment>
</SegmentDecomposition>
<MediaTime>

<MediaRelIncrTimePoint timeBase=“MediaLocator[1]”
timeUnit=“PT1N25F”>5</MediaRelIncrTimePoint>
<MediaIncrDurationtimeUnit=“PT1N25F”>118</MediaIncrDuration>

</MediaTime>
</AudioVisual>
</AudioVisualContent>
</ContentDescription>
</Mpeg7Main>

In this example, the items of semantic information I are shown in bold letters. The description comprises a segment called <Audio Visual> that relates to the whole of the input material Vi. This <Audio Visual> segment in turn comprises 4 entities called <Segment> that relate to 4 video segments. The <Segment> entities comprise in particular entities called <WhatAction>, <Where>, <When> and <How> that respectively describe the nature of the action, the place where the action took place, the time of the action and how the action took place and they contain semantic information. The <Audio Visual> segment and the <Segment> entities each have an attribute “id” that contains a title. This title too is semantic information.

An example will now be given of a plan P that can be used to generate output material Vo from input material Vi that is described in the above description:

Example of Plan

“During the vacation we spent two days in Paris. We stayed at the Beauséjour hotel. We had a walk round the Pantheon. We also visited the Eiffel tower. We finished our trip with a romantic evening meal.

In this example, the output material will comprise 4 video segments contained in the input material Vi but rearranged as follows: “Arrival in Paris”, “Our hotel”, “A walk round the Pantheon”, “Visit to the Eiffel Tower”, “Romantic evening meal”,

To implement step S2-1 for formulating a search criterion, there are a plurality of embodiments that may be used.

In a first embodiment, the search criterion is formed by the whole sentence.

In a second embodiment, one or more significant words are extracted from the sentence Tj (for example by using a dictionary to delete the unwanted words such as articles, prepositions, links between words, etc.). The words extracted are then used independently of one another to form a search criterion.

In a third embodiment, a grammatical analysis is carried out in such a way as to establish logic links between the significant words and the words extracted are then used in combination to form a search criterion. The grammatical analysis is advantageously also used to determine the descriptor that the search should cover for each word or combination of words contained in the search criterion. For example, if the grammatical analysis shows that the first significant word in the sentence is a proper noun relating to a person, the descriptor to be scrutinized for this first word will be the “Who” descriptor. If the grammatical analysis shows that the second significant word in the sentence is a place, the descriptor to be scrutinized for this second word will be the “Where” descriptor, and so on. This being the case, the <Segment> video segment that meets the search criterion is the one where:

the <Who> element contains said first word,

and the <Where> element contains said second word.

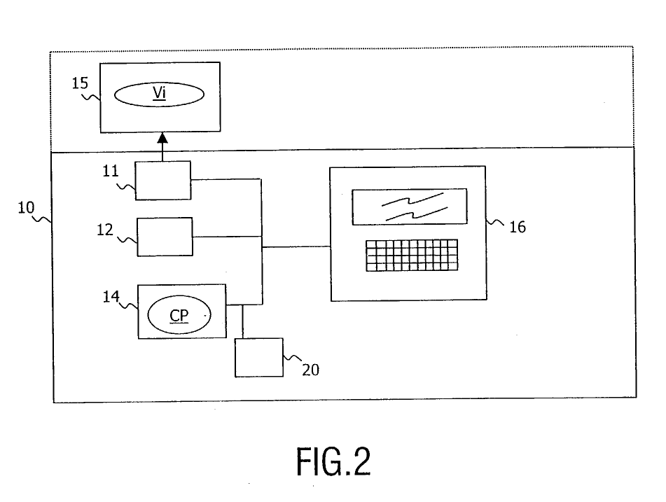

In FIG. 2 is shown an example of an item of electronic equipment according to the invention. As shown in FIG. 2, an item of equipment 10 according to the invention comprises means 11 for reading input material Vi, a program memory 12 and a processor 14. The input material Vi is stored in a data memory 15 that may or may not form part of the item of equipment 10. This data memory 15 may for example be formed by a component such as a hard disk or by a removable medium of the disk, cassette, diskette, etc. type. The item of equipment 10 also comprises a user interface 16 that enables at least the user to enter a plan P for carrying out the composition and editing method according to the invention. Optionally, the user interface 16 also enables semantic information I intended to be used for annotating the description of the input material Vi to be entered. In a first embodiment, the interface 16 is a voice interface. It comprises a microphone and software voice recognition means stored in the program memory 12. As an option, it may also comprise a display screen. In a second embodiment, the interface 16 is a tactile interface. It comprises for example a keyboard and display screen, or a tactile screen.

The program memory 12 contains in particular a program CP that comprises instructions for implementing a composition and editing method according to the invention when the program CP is run by the processor 14. The output material Vo generated by the composition and editing method according to the invention is for example stored in the data memory 15.

In certain cases the item of equipment 10 also comprises means 20 for capturing input material Vi.

1. A composition and editing method for producing output material (Vo) from at least one item of input material (Vi) comprising images and/or image sequences, characterized in that it comprises:
at least one step (S1) for acquiring a plan (P) that is in a plurality of parts (Tj) and relates to said output material,
at least one step (S2) for selecting, from a description (D) of said input material, images and/or image sequences corresponding to said parts,
at least one step (S3) for placing in order, in accordance with said plan, images and/or image sequences selected.

2. A composition and editing method as claimed in claim 1, characterized in that it comprises, to generate said description:
a step (S0-1) for automatically extracting a structure from said input material,
a step (S0-2) for annotating said structure from semantic information (I) supplied by a user (U).

3. A composition and editing method as claimed in claim 1, characterized in that said selecting step comprises:
a step (S2-1) for analyzing said plan (P) to generate at least one search criterion (Q(Tj)) relating to each of said parts (Tj),
a step (S2-2) for searching in said description (D) for one or more images and/or image sequences that satisfy each search criterion (Q(Tj)).

4. An item of electronic equipment fitted with means (11) for reading input material (Vi) comprising images and/or image sequences, and with means (12, 14, 16, CP) for processing said input material to produce output material (Vo) from said input material, characterized in that said processing means comprise:
means for acquiring a plan that is in a plurality of parts and relates to said output material,
means for selecting, from a description of said input material, images and/or image sequences corresponding to said parts,
means for placing in order, in accordance with said plan, images and/or image sequences selected.

5. An item of electronic equipment as claimed in claim 4, characterized in that said selecting means comprise:
means for analyzing said plan to generate at least one search criterion relating to each of said parts,
means for searching in said description for one or more images and/or image sequences that satisfy each search criterion.

6. An item of electronic equipment as claimed in claim 4, characterized in that it comprises, to generate said description:
means for automatically extracting a structure from said input material,
means for annotating said structure from semantic information supplied by a user.

7. An item of electronic equipment as claimed in claim 4, characterized in that it comprises means (20) for capturing said input material.

8. A program (CP) comprising instructions for implementing a composition and editing method as claimed in either of claims 1 and 2 when said program is run by a processor (14).
